(19) United States
(12) Patent Application Publication
(10) Pub. No.: US 2021/0147183 A1
(43) Pub. Date: May 20, 2021

(54) ELEVATOR SYSTEM

(71) Applicant: thyssenkrupp Elevator Innovation and Operations GmbH, Essen (DE)

(72) Inventors: Ronald DIETZE, Jettingen (DE); Lucas Franz MAGER, Schömberg (DE); Thomas KUCZERA, Leinfelden-Echterdingen (DE)

(73) Assignees: THYSSENKRUPP ELEVATOR AG, Essen (DE); thyssenkrupp AG, Essen (DE)

(21) Appl. No.: 16/623,007

(22) PCT Filed: Jun. 20, 2018
(86) PCT No.: PCT/EP2018/066349

§ 371 Date: Dec. 16, 2019

(30) Foreign Application Priority Data
Jun. 20, 2017 (DE) 10 2017 113 571.5

(51) Int. Cl. B66B 5/00; B66B 9/00; B66B 5/02

(52) U.S. Cl. CPC B66B 5/0087; B66B 9/003; B66B 11/0407; B66B 5/027; B66B 5/005

(57) ABSTRACT

An elevator system, including at least one elevator cab, which can be moved at least in the vertical direction in an elevator shaft. A first drive device is provided for moving the at least one elevator cab. A platform device is provided, said platform device including a platform and a second drive device for moving the platform, wherein the platform is movable in the vertical direction and in at least one horizontal direction in the elevator shaft, wherein the second drive device is independent of the first drive device.

The present invention relates to an elevator system and a method for the maintenance of an elevator system.

### PRIOR ART

In conventional elevator systems it is generally possible, for example, to carry out maintenance work in a simple manner from a roof of an elevator car. By moving an elevator cab inside the elevator shaft, substantially the entire elevator shaft is accessible to maintenance personnel. It is also possible to carry out a potentially required evacuation from a damaged elevator cab in the conventional manner via the cab roof.

In modern elevator systems, for example in shaft-changing multi-shaft systems, as is disclosed, for example, in DE 10 2015 102 564 A1, it is often not possible for maintenance personnel to be carried by the elevator and/or to have access to a cab roof in such a manner. This is because such elevator cabs are designed, for example, in a lightweight construction, wherein the cab roof is not able to bear the weight of one or more persons.

Thus it is desirable to provide a system which as far as possible is simple, low-cost, permanently available and quickly ready for use, a simple accessibility to an elevator shaft being able to be ensured thereby such that, for example, maintenance personnel may carry out appropriate maintenance work in the shaft and/or damaged elevator cabs may be evacuated.

### DISCLOSURE OF THE INVENTION

According to the invention, an elevator system having the features of claim 1 and a method having the features of claim 10 are proposed. Advantageous embodiments form the subject matter of the subclaims and the following description.

An elevator system according to the invention comprises at least one elevator cab which can be moved at least in the vertical direction, wherein a first drive device is provided for moving the at least one elevator cab. The elevator system further comprises at least one platform device comprising a platform and a second drive device for moving the platform. The platform in this case is also movable in the vertical direction and additionally in at least one horizontal direction in the elevator shaft, wherein the second drive device is independent of the first drive device. With such a platform device, a flexible and simple accessibility to different portions and/or regions of an elevator shaft is provided independently of an elevator cab. By the independence of the second drive device, which serves for moving the platform of the platform device, from the first drive device, which serves for moving the at least one first elevator cab, such an accessibility is reliably provided even in the event of a malfunction of the first drive device. The platform is expediently dimensioned such that a desired number of maintenance personnel is accommodated thereon.

According to a preferred embodiment, a plurality of elevator cabs, in particular at least two, three or four further elevator cabs which are movable independently of one another in the elevator shaft, are provided. An elevator system thus configured comprises a greater conveying capacity relative to elevator systems having only one cab in an elevator shaft. In this embodiment, it may be expedient to provide a plurality of platform devices. This measure is expedient, in particular, when the elevator cabs are movable independently of one another in a shaft having only one travel path, i.e. the elevator cabs are always positioned vertically above one another. In this case, it may be expedient to provide a platform device respectively between two vertically adjacent elevator cabs.

It is particularly preferred if the elevator shaft comprises a plurality of travel paths, in particular at least two, three, four or five travel paths for elevator cabs extending parallel to one another and running adjacent to one another, wherein the elevator cabs are configured to be movable along the travel paths, in particular vertically and in particular horizontally between the travel paths. According to this embodiment, in particular by correspondingly moving all of the elevator cabs out of a specific travel path, it is possible to move a correspondingly dimensioned platform along the entire travel path, i.e. along the entire length of the elevator shaft. In the case of damage to an individual elevator cab, which for example is arrested within a travel path, by moving further elevator cabs out of this travel path it is also possible to guide the platform device from above or from below toward the damaged elevator cab.

According to a preferred embodiment, the horizontal direction in which the platform of the platform device is movable corresponds to a depth direction or a width direction of the elevator shaft. “Depth direction” is understood, in particular, as the direction of the elevator shaft which extends perpendicular to the surfaces of the elevator doors, i.e. the floor doors and cab doors. “Width direction” is accordingly understood as a direction parallel to the surfaces of the elevator doors.

In this case, it is preferred if the platform device extends substantially over an entire horizontal direction of extension of the elevator shaft. If the platform of the platform device, for example, extends over the entire width and/or width direction of the elevator shaft (i.e. a direction perpendicular to the depth direction and/or parallel to the surfaces of the elevator doors) substantially every location in the shaft is able to be reached and/or controlled by a vertical and a subsequent horizontal movement of the platform device.

According to a particular embodiment of the elevator system according to the invention, the at least one elevator cab and the platform of the at least one platform device are movable parallel to one another in the vertical direction, without their respective surfaces which project into a horizontal plane overlapping. This means that the platform is always movable irrespective of a positioning of one or more elevator cabs in the entire elevator shaft and, in particular, also past a stationary elevator cab. This embodiment is suitable, in particular, for elevator testing systems in which different elevator projections and/or configurations are tested.

In a further embodiment, the platform device comprises a deflection device. In one operating mode of the elevator system, the platform may be moved (deflected) by means of the deflection device, i.e. if required, for example when a repair is to be made to the first drive device or an elevator cab, such that the surfaces of the elevator cab and the platform which project into the horizontal plane overlap. Thus mechanics may travel safely through the elevator shaft on the platform on a separate travel path which is spaced apart from the travel path of the cabs. In the case of maintenance, the elevator system is put into an operating mode which permits the platform to be moved (for example pivoted) into the travel path of the cabs, without the risk being present of a collision with one of the cabs. For example, the deflection device may be designed as a pivoting arm which moves the platform relative to the second drive device and thus pivots said platform into the travel path of the cabs.

Expediently, the first drive is configured as a linear drive, the at least one first elevator cab being movable thereby. Such linear drives are able to be advantageously used, in particular, in the case of elevator systems having a plurality of cabs which are movable independently of one another in a shaft, since in this case costly and complex cable guidance systems may be dispensed with. In particular, linear drives are able to provide both a vertical and a horizontal mobility of the elevator cabs.

Advantageously, the second drive device is configured as a cable drive, the platform of the platform device being movable thereby. In this case, in particular, a winding drum elevator is conceivable, in which the support cables of the platform device are wound onto and off a drum which is arranged in the shaft head. However, a drive disk mechanism with a counterweight is also conceivable in this connection. It is also possible to provide a second platform which is fastened to a cable of the cable drive such that this second platform forms a counterweight relative to the (first) platform.

Further preferred drive devices for the platform device are a hydraulic drive, a toothed rod drive or a vacuum drive. It is particularly advantageous if the drive of the platform device is independent of the drive of the at least one elevator car so that, in particular in the event of a malfunction of the first drive device, for example in the case of a power failure, an emergency operation of the platform device, for example for evacuating people from an elevator cab, is possible. In this connection it might also be conceivable to drive the platform device by means of a second linear drive which is independent of the first drive, in particular when said linear drive comprises a power supply which is independent of the power supply of the linear drive of the elevator cabs.

According to a preferred embodiment, the platform comprises an accessible surface, the size thereof being of variable configuration.

In this case, it is preferred, in particular, that the platform comprises at least one region which may be folded out and/or telescopically extended. By means of such a region, the requirement for a horizontal mobility of the platform may be effectively reduced. For example, it is possible to move the platform within a travel path adjacent to the travel path of an arrested, in particular damaged, cab and subsequently, for example, to fold out and/or extend in a position slightly below the arrested cab the region which may be folded out or telescopically extended, in order to permit in this manner access by maintenance personnel to a region below the arrested cab.

Expediently, the platform comprises a device for providing a releasable anchoring to a shaft wall or a framework in the elevator shaft. By means of such an anchoring it may be ensured that the platform does not tilt, for example, when a region which is folded out or telescopically extended is accessed. Such an anchoring may also be provided at the end of the region which may be folded out or telescopically extended. For example, it is conceivable to move the region which may be folded out or extended toward a shaft wall such that an engagement with a mechanism provided therein is possible.

The method according to the invention for the maintenance or repair or evacuation of an elevator system comprises the steps of establishing or initiating that an elevator cab is and/or is to be arrested at a current position, moving the platform into a position below, above or adjacent to the arrested cab, so that maintenance or repair or evacuation of the cab may be carried out from the platform, as well as subsequently maintaining, repairing or evacuating said cab. Expediently, when the elevator system comprises at least one further cab, the method comprises setting up a blocked zone around the arrested cab, i.e. for example above and/or below and/or upstream and/or downstream in the direction of travel, and in the event that further elevator cabs are located in the blocked zone, moving these elevator cabs out of the blocked zone.

By means of this method an effective guidance of the platform into the region of an arrested, in particular damaged, elevator cab is possible in a simple manner. The provision of a blocked zone in this case ensures optimal safety for maintenance or emergency rescue personnel. The blocked zone, in particular, is selected such that an unhindered movement of the platform to a desired location in the surroundings of the arrested cab is possible. According to a particular embodiment of this method, a step of securing the arrested cab from crashing down is also provided. To this end, for example, a corresponding securing mechanism may be actuated manually or automatically. For example, it is possible to move the platform initially into a region slightly above the arrested cab and in this position to carry out a manual or automatic securing of the elevator cab to the shaft wall. After the maintenance or evacuation is completed, such a securing device may then be released again manually or automatically.

Expediently, the method according to the invention comprises moving the platform into a position adjacent to the arrested cab, wherein subsequently the at least one region of the platform which may be folded out and/or telescopically extended is moved into a position below the arrested cab. This permits access to maintenance personnel from a position below the cab in a simple manner.

Further advantages and embodiments of the invention are disclosed in the description and the accompanying drawings.

It goes without saying that the features cited above and to be described in more detail below are not only able to be used in the respectively specified combination but also in other combinations or individually without departing from the scope of the present invention.

The invention is shown schematically in the drawings with reference to an exemplary embodiment and is described hereinafter with reference to the drawings.

### DESCRIPTION OF THE FIGURES

FIG. 1 shows schematically a preferred embodiment of an elevator system according to the invention in a lateral view,

FIG. 2 shows in a schematic horizontal sectional view a further preferred embodiment of an elevator system according to the invention,

FIG. 3 shows in the form of a further schematic horizontal sectional view a further preferred embodiment of the elevator system according to the invention,

FIG. 4 shows in the form of a further schematic horizontal sectional view a further preferred embodiment of the elevator system according to the invention, in particular for describing a preferred embodiment of the method according to the invention,

FIG. 5 shows a schematic lateral sectional view of the embodiment of the elevator system according to FIG. 4, also for illustrating a preferred embodiment of the method according to the invention,

FIG. 6 shows in the form of a further schematic horizontal sectional view a further preferred embodiment of the elevator system according to the invention, which shows the alternative arrangement of the platforms to the arrangement in FIG. 4,

FIGS. 7a-c show a schematic lateral sectional view of the embodiment according to FIG. 6, wherein the arrangement of the platforms in the elevator shaft respectively differ from one another, and

FIG. 8 shows schematically a perspective view of the platform device according to an exemplary embodiment.

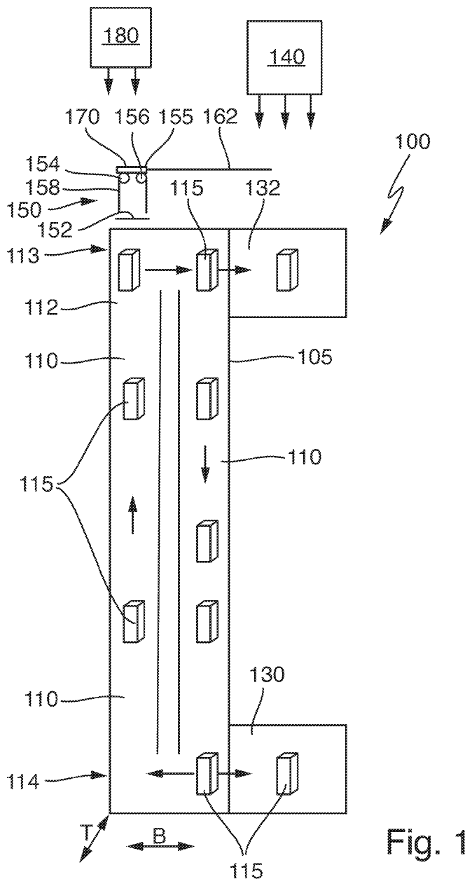

In FIG. 1 an embodiment of an elevator system according to the invention is shown schematically and denoted as a whole by 100. The elevator system 100 comprises an elevator shaft 105 which comprises a number of travel paths 110 running vertically adjacent to one another. In the present example two travel paths 110 are provided.

The travel paths 110 are connected together via connecting portions 113, 114. The connecting portions 113, 114 are preferably provided in an uppermost and/or lowermost floor of the elevator shaft 105. The lowermost floor is, for example, a basement, the uppermost floor is, for example, the 10th or the 20th floor. A plurality of elevator cabs 115 is movable in the elevator shaft 105. The cabs 115 may alternate to and fro between the respective travel paths 110 via the connecting portions 113 and 114. Expediently the cabs 115 are only moved upwardly along the left-hand travel path 110 and only moved downwardly along the right-hand travel path 110, as is indicated by corresponding arrows. The cabs 115 as a whole are operated as a shaft-changing multi-cab system.

In addition to the elevator shaft 105, cab receiver shafts 130, 132 are provided. Cabs 115 which are currently not required, for example due to a correspondingly small volume of traffic, are temporarily stored in these cab receiver shafts 130, 132 which are expediently configured in the lowermost floor and in the uppermost floor. The cab receiver shafts may also be used for the maintenance of cabs.

The cabs 115 are movable by means of a linear drive (not shown in FIG. 1) along the travel paths 110 and the connecting portions 113, 114 and into and out of the receiver shafts 130, 132. A control unit 140 which controls the cabs is shown schematically and denoted by 140.

A platform device 150 is provided above the upper connecting portion 113. This platform device 150 comprises a platform 152 and a second drive device 154. The second drive device 154 comprises support means 155. The support means are configured, for example, as cable winches, which in each case comprise rollers 156 and cables 158 which may be wound onto and off said rollers. The second drive device 154 further comprises a carriage 170 which is displaceable on horizontal guide rails 162. The cable winches are attached to the carriage 170 which is movable along the horizontally extending guide rails 162. By actuating the cable winches, i.e. winding the cables 158 onto and/or off the rollers 156, the platform 152 may be lowered into the elevator shaft 105 and, if required, positioned at any location therein by moving the carriage 170 along the rails 162. The platform device is controllable by a further control device 180. The control devices 140 and 180 may also be designed as a single control device.

In the present exemplary embodiment it should be assumed that in the width direction B the platform does not extend over the entire horizontal extent of the shaft 105. In the depth direction, however, it should be assumed that the platform extends substantially over the entire extent in the depth direction of the shaft. For example, the projection of the platform into a horizontal surface may correspond approximately to the corresponding projection of an elevator cab 115. In order to ensure, for example, unhindered access to the entire left-hand travel path 110, before lowering the platform 152 all elevator cars 115 may be removed from the left-hand travel path 110, for example by moving into the right-hand travel path 110 and/or the cab receiver shafts 130, 132. By moving the carriage 160 along the rail 162, the platform 152 may also be positioned above the right-hand travel path 110 and correspondingly lowered, wherein in this case expediently all of the cabs 115 are removed from the right-hand travel path. Alternatively, the platform may also be initially lowered and then horizontally displaced. A simultaneous lowering and horizontal movement of the platform is also conceivable.

Similarly, for example, an evacuation of a damaged and/or arrested elevator cab 115 in a travel path is also possible. In this case, for example, all of the cabs above a damaged cab 115 may be removed out of the corresponding travel path and the platform 152 may then be lowered down to the damaged cab 115.

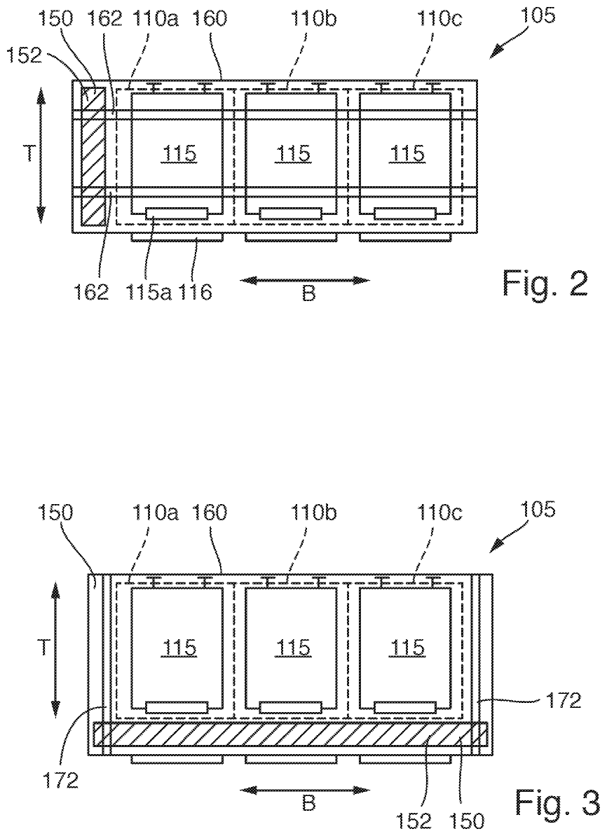

A further embodiment of the elevator system according to the invention is shown in FIG. 2 in a schematic plan view (vertically from above), i.e. corresponding to a projection into a horizontal plane. Here, an elevator shaft 105 is identified, in which three adjacent vertically extending travel paths 110a, 110b, 110c (in each case indicated by dashed lines) are provided. Elevator cabs 115 are movable in each travel path 110a, 110b, 110c, wherein in the perspective view of FIG. 2 in each case only one cab 115 is able to be shown for each travel path.

A platform device 150, as already described with reference to FIG. 1, is movable along rails 162 which are arranged above the connecting portion 113 (not shown in FIG. 2) in the width direction B of the shaft. In FIG. 2 a view of the winch components of the platform device 150 has been dispensed with. According to this embodiment, the platform 152 extends substantially over the entire extent of the shaft 105 in the depth direction T, wherein the extent in the width direction B is relatively small, for example 20-40 cm.

The cabs 115 are movable vertically by means of a linear drive 160 along the travel paths 110a, 110b, 110c, wherein for the sake of clarity only the rails of the linear drive 160 which are located on the respective rear faces of the cabs 115 are shown. Cab doors 115a which cooperate with corresponding shaft doors (schematically shown and denoted by 116) are located on the front faces of the cabs 115.

In the case of damage to a cab 115 in the central travel path 110b, for example, the platform 152 of the platform device 150 is moved along the rails 162 into a position above this travel path and subsequently correspondingly lowered, wherein, as described, optionally cabs functionally blocking the path are removed from the travel path of the platform 152 and/or the central travel path 110b. It is also possible to lower the platform 152 along an adjacent travel path as far as the level of the damaged cab 115.

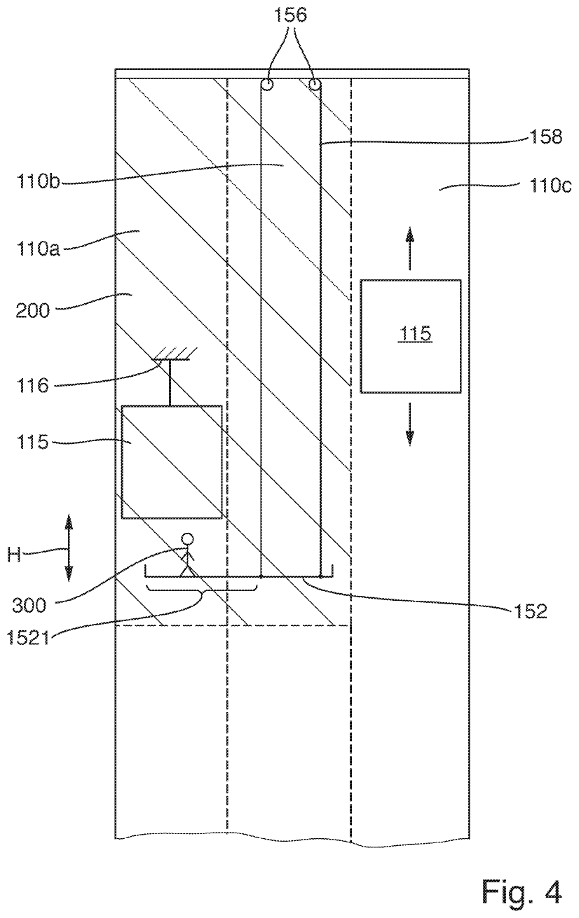

In FIG. 3 a further embodiment of an elevator system according to the invention is shown. The same components as have already been described with reference to FIGS. 1 and 2 are denoted here by the same reference numerals. The essential difference from the embodiment according to FIG. 2 is that the platform 152 in the present case extends substantially over the entire extent of the shaft in the width direction B. The extent of the platform 152 in the depth direction T is relatively small, for example 20-90 cm, in particular 30, 40, 50, 60 or 70 cm. According to this embodiment, rails 172 running in the depth direction T are provided for displacing the platform device in the depth direction T. It is also possible to configure the platform 152 to be telescopically extendable in the depth direction T, so that a displaceability along rails 172 in the depth direction over the entire extent of the shaft may be entirely or partially dispensed with.

Common to all of the embodiments of the platform 152 shown is that with a displaceability in only one horizontal direction, for example the width direction or depth direction, all of the positions in a horizontal plane in the shaft may be reached and/or approached. It is also conceivable to design the platform to be movable in two horizontal directions, in particular perpendicular to one another. In this case, the platform 152 may be dimensioned to be correspondingly smaller.

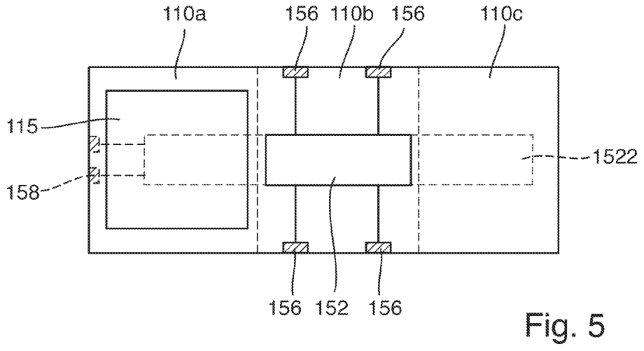

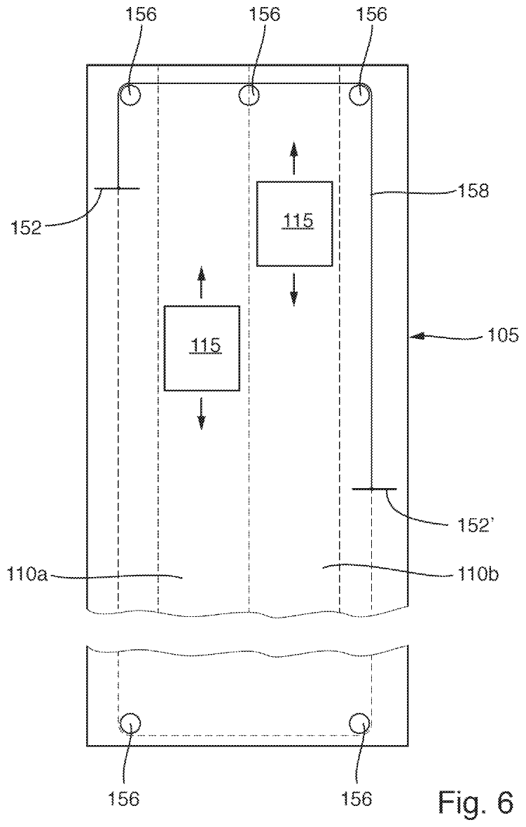

With reference to FIGS. 4 and 5, in particular, a preferred embodiment of the method according to the invention is now described in more detail. It should be noted that in FIGS. 4 and 5 the view of different components which have been described, for example, with reference to FIG. 1 has been dispensed with. Drives and control devices might be cited as examples thereof.

It should be assumed here that the cab 115 shown in FIGS. 4 and 5, in each case in the left-hand travel path 110a, is defective, i.e. may not move from its current position in the left-hand travel path 110a. This state is identified by the control unit 140 (not shown in FIGS. 4 and 5). The defective cab, therefore, in the wording of the claims, is an arrested cab. For carrying out a repair and/or evacuation of the arrested cab 115, the control unit 140 initially defines a blocked zone around the arrested cab 115. This blocked zone expediently encompasses a region of the left-hand travel path 110a above and below the arrested cab 115 and a corresponding region in the adjacent (central) travel path 110b. The blocked zone is shown in FIG. 4 by coarse hatching and denoted by 200. The blocked zone 200 is defined such that a movement of further cabs 115 of the elevator system 100 into the blocked zone is prevented. Cabs 115 which are possibly located in the blocked zone may be moved out of the blocked zone. Cabs which are located outside the blocked zone 200 may be moved further, as long as they remain outside the blocked zone.

The platform 152 is now moved along the central travel path 110b, i.e. the travel path adjacent to the travel path 110 of the arrested cab 115, into a position slightly below the lower edge of the cab 115. For example, the spacing H selected here between the height of the cab and the lower face of the elevator car 115 is 1.5 m to 2 m.

Subsequently, a telescopically extendable region 1521 of the platform 152 is moved below the arrested cab 115. The vertical spacing between the extended region 1521 and the lower edge of the cab 115 thus substantially corresponds to the height H. The spacing thus selected permits service personnel or emergency rescue personnel 300 to move on the platform 152 in a region below the cab 115 and to carry out possibly required maintenance, repair or evacuation measures from that point.

Expediently, before an operator 300 enters the region below the cab 115, the cab 115 is secured against crashing down. This may be implemented, for example, by the corresponding triggering of braking or catch devices (not shown here) by the control unit 140. It is also conceivable to secure the arrested cab 115 manually from the platform 152, for example when the platform 152 is lowered from an upper region of the shaft into the vicinity of the arrested cab. For example, the platform may be stopped approximately at the level of the roof of the arrested elevator car, so that an operator may secure the cab in the shaft by means of a securing device, possibly by extending the telescopically extendable region 1521. Such a securing device is shown schematically in FIG. 5 and denoted by 116.

Expediently, in order to prevent the platform 152 from tilting in the event of an operator 300 being located on the extended region 1521, a releasable anchoring of the platform 152 may also be provided, for example, to a shaft wall or a framework provided inside the shaft. Corresponding anchorings are shown schematically in FIG. 5 and denoted by 156. It is also conceivable to secure and/or to anchor the extended region 1521 to a shaft wall. A corresponding securing, which may comprise, for example, extendable bars which are brought into engagement with a shaft wall, is shown schematically and denoted by 158.

According to a particularly preferred embodiment, the platform 152 may be configured with a telescopically extendable region toward the two sides. In FIG. 4 in addition to the aforementioned region 1521 a further extendable region 1522 (shown in dashed lines) is identified. It is also possible to provide a region which is selectively movable into the two positions according to 1521 and/or 1522 shown in dashed lines.

It is also conceivable that the platform 152 is movable in three directions in the elevator shaft, namely for example in the vertical direction (by actuating the support means shown in FIG. 1), i.e. by winding the cables 158 onto and/or off the respective rollers 156. A mobility in both horizontal directions is thus able to be provided by moving the carriage 170 described with reference to FIG. 1 along the rails 162 in the first direction and by providing a second set of rails, which extends perpendicular to the rails 162 in the horizontal direction, in a second horizontal direction.

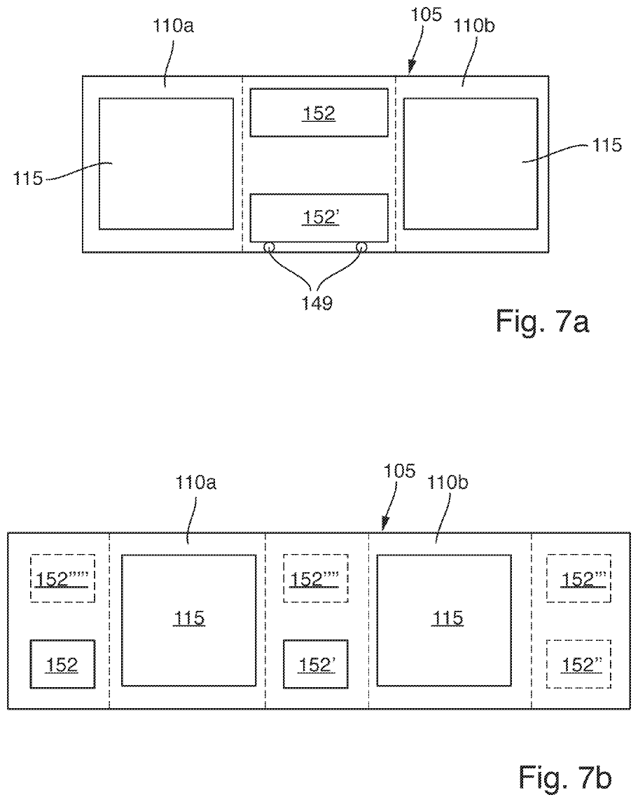

FIG. 6 shows an alternative exemplary embodiment to FIG. 4, wherein the embodiments described with reference to FIG. 4 may nevertheless also be applied to the exemplary embodiment of FIG. 6, unless indicated otherwise. A platform 152, as is already shown in FIG. 4, is shown in FIG. 6. The platform 152 is fastened to the cable 158 which is guided via rollers 156. The platform 152 is arranged in the elevator shaft 105 between a first shaft wall and the first travel path 110a. In other words, a vertical projection of the platform 152 is located between a vertical projection of the cab 115, which is located on the first travel path 110a, and the first shaft wall, advantageously without the vertical projection of the cab 115 and the platform 152 overlapping. The first shaft wall, in the case of a rectangular bottom surface of the elevator shaft 105, may be regarded as the shaft wall which is located closest to a side wall of the cab 115. The side wall of the cab is to be understood as the walls which adjoin the front cab wall, i.e. the cab wall in which the cab door is integrated, and form neither the bottom panel nor the ceiling panel.

The exemplary embodiment of FIG. 6 further shows a second platform 152′. The second platform 152′ is arranged on the side of the cable 158 which is remote from the side of the cable 158 on which the platform 152 is arranged. In other words, the first platform 152 and the second platform 152′ are arranged at the two opposing cable ends of the cable 158. The second platform 152′ forms a counterweight for the first platform 152 and vice versa. The second platform 152′ in the elevator shaft 105 is arranged between a second shaft wall and the travel path 110b. In other words, a vertical projection of the platform 152 is located between a vertical projection of the cab 115 which is located on the second travel path 110b and the second shaft wall. In the case of a rectangular bottom surface of the elevator shaft 105, the second shaft wall may be regarded as the shaft wall which is located closest to a side wall of the cab 115. The side wall of the cab is to be understood as the walls which adjoin the front cab wall, i.e. the cab wall in which the cab door is integrated, and form neither the bottom panel nor the ceiling panel.

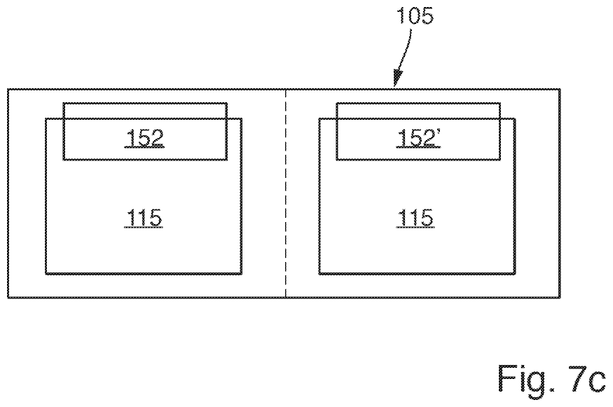

In other words, the cable 158 on which the first platform 152 and the second platform 152′ are arranged may span two adjacent travel paths 110a, 110b. Cabs 115 which are located in the first travel path 110a are able to be reached by means of the first platform 152 and cabs 115 which are located in the second travel path 110b are able to be reached by means of the second platform 152′. Optionally, the cable 158 may be guided further below the first and the second platform 152, 152′ and joined together over further deflection rollers 156 which are arranged, for example, at the bottom of the elevator shaft 105, so that a closed cable circuit is formed. This is advantageous, for example, in order to guide the platforms, in particular in order to reduce or even to avoid rocking movements of the first platform 152 and/or the second platform 152′. As an alternative to the circulating cable 158, instead of the deflection rollers 156 this cable may also be wound onto the rollers in order to guide the platforms. An alternative guidance of the platforms may be implemented by means of a guide rail on a shaft wall of the elevator shaft (see 149 in FIG. 7a).

One of the rollers 156, for example the roller shown centrally, may be configured as a second drive device, for example as a drive disk or winch, in order to be able to move the platforms 152 and 152′ (in the vertical direction). Due to the arrangement of the two platforms, the first platform 152 and the second platform 152′ move in opposing directions to one another. For example, it is possible to suspend the two platforms in a 1:1 or a 2:1 ratio. In all of the exemplary embodiments the platforms 152 may generally also form a (partially) closed space, for example a cab or a gondola.

FIGS. 7a to 7c show various different arrangements of the first and the second platform 152, 152′ in the elevator shaft in a plan view, comparable with the view of FIG. 5. The arrangement of the first platform 152 and the second platform 152′ is selected such that the first platform 152 and the second platform 152′ are arranged between the first travel path 110a and the second travel path 110b. It should be noted that the first and the second platform, and the cable on which the platforms are suspended, are arranged in the connecting portion between the first travel path 110a and the second travel path 110b such that it is possible for the cabs 115 which change travel path to cross over. Alternatively, a cableless drive, for example one such drive of the aforementioned drives, may also be used in order to move the platforms, instead of the cable drive. Depending on the type of drive, it is possible to move the platform in a guided and/or unguided manner. For example, guide rails 149 may be provided as a guide.

FIG. 7b shows a possible arrangement of a plurality of platforms 152 to 152 in an elevator system, wherein in the case of platforms which are cable-operated, preferably pairs of platforms are formed, forming a counterweight for the respective other platform of the pair. Thus for example, the platforms 152 and 152′ or the platforms 152 and 152 may form a pair. It is also possible that the platforms 152 and 152″″ form a pair. If the platforms 152′ and 152″″ form a pair, the platform 152 together with the platform 152″ may form a pair. The deflection rollers for the cable connecting the platforms of a pair thus may be correspondingly arranged in order to permit a suitable cable guidance for the cabs. The platform 152 is only selected by way of example as a starting point for the description of possible platform pairs. Corresponding pairs which are based on the other platforms may also be formed.

FIG. 7c shows a possible state of two different exemplary embodiments. In one exemplary embodiment the platforms 152, 152′ are (exclusively) guided without cables, for example in that the platforms 152, 152′ use the guide rails of the linear drive of the cabs 115. However, only the outermost cab is then able to be reached by the platform. If a plurality of cabs are located in the same travel path and if the cab which is intended to be reached by the platform is not the outermost cab, expediently the cabs which are located between the platform and the cab to be reached, have to be moved into a different travel path.

In the second exemplary embodiment, the platform 152, 152′ is moved by means of a combination of a guided and an unguided drive. In other words, the platform 152, 152′ may use the guide rails of the linear drive of the cabs until it comes in the vicinity of a cab which is located in the travel path of the platform. If this is not the cab which is intended to be reached by the platform, the platform may be uncoupled from the guide rails and guided via a cable outside the travel path of the cabs. After the platform has passed the corresponding cab, the platform may again be coupled and/or threaded into the guide rails of the linear drive of the cabs. For the coupling and uncoupling (or even threading in and out), a device which pivots the elevator cab from the position in the travel path to a position outside the travel path and vice versa may be provided on the platform and/or the elevator shaft.

If the platform is intended to pass a cab, the cab may be conveyed out of the travel path of the cabs in the following manner: a suspension of the cable, on which the platform is suspended, if it is uncoupled from the guide rails of the cabs, may be movably arranged in the elevator shaft, i.e. for example on the ceiling of the elevator shaft. If the platform moves in the guide rails of the cabs, therefore, the cable may be suspended above the platform, i.e. inside a vertical projection of the travel path. For passing the cab the platform may be uncoupled from the guide rails of the cab so that the platform is (only just) retained by the cable. The suspension of the cable in the elevator shaft may be moved such that it is moved out of the travel path, whereby the platform which is connected to the suspension by means of the cable is also moved out of the travel path. Potential rocking movements of the platform may be reduced, for example, by a suitable balancing control device using weights or by frictional guidance on the cab shaft. Generally, a slight rocking of the platform is not particularly critical, since the platform is only used for the transport of specialist trained personnel who may be expected to be secured by a safety belt when the platform is moving.

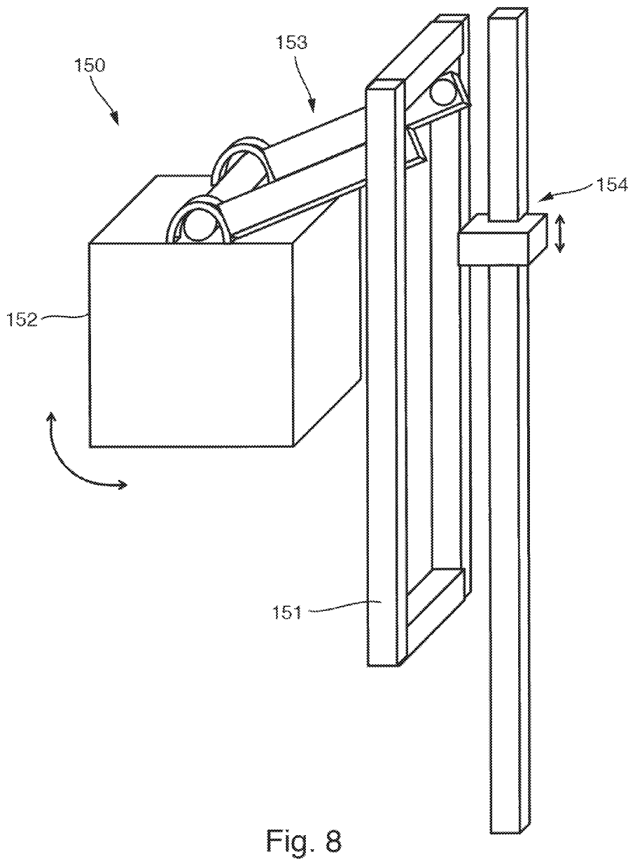

FIG. 8 shows a schematic view of the platform device 150 according to an embodiment. The platform device 150 comprises the platform 152, shown here in the form of a cab, as well as a frame 151. The platform 152 and the frame 151 are movably connected together (mechanically) by means of a deflection device 153. A deflection device in the form of a (rigid) rocker is shown. The deflection of the platform 152 may be carried out, if required, by means of a further drive device which may move the deflection device 153 in a rotational manner relative to the frame 151. Also possible are other deflection devices which only protrude into the travel paths if required, such as for example telescopic arms/telescopic rails, which connect the frame 151 to the platform 152 and which are extended if required. The frame 151 may also be moved (vertically) by means of the second drive device 154. Reference is made to the above description regarding the possible types of drive of the second drive device, in order to move the platform. Advantageously, the second drive device and/or part of the second drive device, which is fixedly mounted in the elevator shaft, is mounted on the shaft wall where the doors are located for the passengers to enter and exit the elevator. At this point the second drive device does not collide with the guide rails of the connecting portion.

The embodiment of the platform device shown is advantageous in that the platform 152 may be arranged inside the frame 151 when said platform is moved (vertically). By means of the deflection device 153 the frame 151 and the platform 152 may be connected together (mechanically). Advantageously, the platform device in this state (inside the frame) is located outside the travel path of the cabs. For the maintenance of the cabs or the (linear) drive of the cabs, the platform 152 may be transferred into the travel path of the cabs so that, in particular, the guide rails located on the shaft wall, the (linear) drive etc. may be inspected. Once the works are completed, the platform 152 is positioned once again inside the frame 151 so that the platform device 150 does not constitute an obstruction to the cabs. In order to be able to deflect the platform, the frame is connected to the frame by means of the deflection device.

1.-18. (canceled)

19. An elevator system, comprising:
a first elevator cab which is configured to move at least in the vertical direction in an elevator shaft;
a first drive device configured to move the first elevator cab;
a platform device, comprising:
a platform; and
a second drive device configured to move the platform,
wherein the platform is movable in the vertical direction and in at least one horizontal direction in the elevator shaft, wherein the second drive device is independent of the first drive device.

20. The elevator system of claim 19, comprising at least one further elevator cab, wherein the first and the at least one further elevator cab are movable independently of one another in the elevator shaft.

21. The elevator system of claim 19 wherein the elevator shaft comprises a plurality of travel paths for elevator cabs extending parallel to one another and running adjacent to one another, wherein the elevator cabs are configured to be movable between the travel paths.

22. The elevator system of claim 19 wherein the horizontal direction in which the platform is movable is a width direction or a depth direction of the elevator shaft.

23. The elevator system of claim 19 wherein the platform extends substantially over an entire horizontal extent of the elevator shaft.

24. The elevator system of claim 19 wherein the elevator cab and the platform are movable parallel to one another in the vertical direction, without their respective surfaces which project into a horizontal plane overlapping.

25. The elevator system of claim 24 wherein in one operating mode of the elevator system the platform device comprises a deflection device which is configured to move the platform such that the surfaces of the elevator cab and the platform which project into the horizontal plane overlap.

26. The elevator system of claim 25 wherein the deflection device comprises a pivoting arm which is configured to move the platform relative to the second drive device.

27. The elevator system of claim 19 wherein the first drive device is configured as an electrical linear drive.

28. The elevator system of claim 19 wherein the second drive device is configured as a cable drive.

29. The elevator system of claim 28, wherein the platform device comprises a second platform arranged on a cable of the cable drive such that the second platform forms a counterweight relative to the platform.

30. The elevator system of claim 19 wherein the platform comprises an accessible surface, the size thereof being of variable configuration.

31. The elevator system of claim 19 wherein the platform comprises at least one region which may be folded out and/or telescopically extended.

32. The elevator system of claim 19 wherein the platform comprises at least one device for providing a releasable anchoring to a shaft wall or a framework in the elevator shaft.

33. A method for the maintenance or repair or evacuation of an elevator system comprising at least one elevator cab which can be moved at least in the vertical direction, wherein a first drive device is provided for moving the first elevator cab, wherein the elevator system further comprises a platform device which comprises a platform and a second drive device for moving the platform, wherein the platform is movable in the vertical direction and in at least one horizontal direction in the elevator shaft, wherein the second drive device is independent of the first drive device, wherein the method comprises the following steps:
establishing or initiating that the first elevator cab is and/or is to be arrested at a current position,
moving the platform into a position below, above or adjacent to the arrested elevator cab so that maintenance or repair or evacuation of the elevator cab may be carried out from the platform, and
maintaining, repairing or evacuating the arrested first cab from the platform.

34. The method of claim 33 wherein the elevator system comprises at least one further elevator cab, comprising the following further steps:
setting up a blocked zone (200) around the arrested first elevator cab,
when at least one further elevator cab is located in the blocked zone, moving the at least one further elevator cab out of the blocked zone.

35. The method of claim 33, further comprising the step of securing the arrested first cab from crashing down.

36. The method of claim 33 wherein the platform is moved into a position adjacent to the arrested first cab and subsequently at least one region of the platform, which is folded out and/or telescopically extended, is moved into a position below the arrested first cab.
